(19) United States
(12) Patent Application Publication
(10) Pub. No.: US 2015/0043023 A1
(43) Pub. Date: Feb. 12, 2015

(54) IMAGE PROCESSING SYSTEM, NON-TRANSITORY COMPUTER READABLE MEDIUM, AND IMAGE PROCESSING METHOD

(71) Applicant: FUJI XEROX CO., LTD., Tokyo (JP)

(72) Inventor: Kensuke ITO, Kanagawa (JP)

(73) Assignee: FUJI XEROX CO., LTD., Tokyo (JP)

(21) Appl. No.: 14/186,389

(22) Filed: Feb. 21, 2014

(30) Foreign Application Priority Data
Aug. 7, 2013 (JP) 2013-163842

(51) Int. Cl. G06K 15/02; G06K 15/00

(52) U.S. Cl. CPC G06K 15/1822; G06K 15/4095
USPC 358/1.14

(57) ABSTRACT

An image processing system includes a randomness feature information acquiring section that acquires randomness feature information from an individual object having randomness unique to an outward appearance of the individual object, the randomness feature information representing a feature of the outward appearance, a coded information attaching section that attaches coded information of the acquired randomness feature information to the individual object corresponding to the coded information, and a verifying section that verifies whether the randomness feature information corresponding to the coded information of the individual object attached with the coded information is the randomness feature information acquired from the individual object attached with the coded information.

### CROSS-REFERENCE TO RELATED APPLICATIONS

This application is based on and claims priority under 35 USC 119 from Japanese Patent Application No. 2013-163842 filed Aug. 7, 2013.

### BACKGROUND

### Technical Field

The present invention relates to an image processing system, a non-transitory computer readable medium, and an image processing method.

### SUMMARY

According to an aspect of the invention, there is provided an image processing system including a randomness feature information acquiring section that acquires randomness feature information from an individual object having randomness unique to an outward appearance of the individual object, the randomness feature information representing a feature of the outward appearance, a coded information attaching section that attaches coded information of the acquired randomness feature information to the individual object corresponding to the coded information, and a verifying section that verifies whether the randomness feature information corresponding to the coded information of the individual object attached with the coded information is the randomness feature information acquired from the individual object attached with the coded information.

### BRIEF DESCRIPTION OF THE DRAWINGS

Exemplary embodiments of the present invention will be described in detail based on the following figures, wherein:

FIG. 1 illustrates an example of the configuration of an image processing system according to a first exemplary embodiment of the invention;

FIG. 2 is a block diagram illustrating an example of functions respectively executed by a reading device, an image forming device, and a verifying device according to the first exemplary embodiment; and

FIG. 3 illustrates an example of the configuration of an image processing system according to a second exemplary embodiment.

### DETAILED DESCRIPTION

### First Exemplary Embodiment

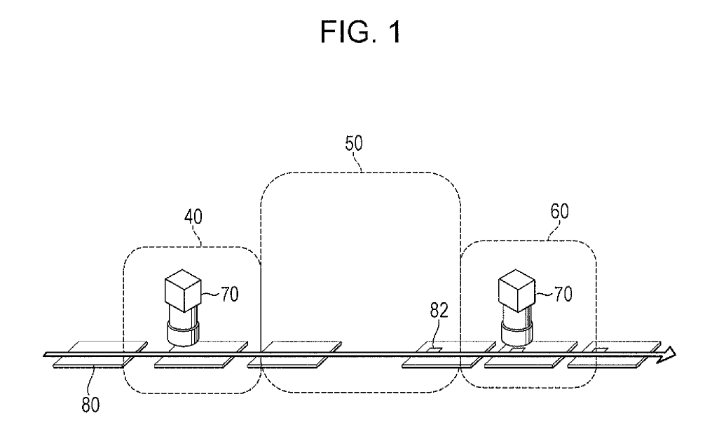

FIG. 1 illustrates an example of the configuration of an image processing system according to a first exemplary embodiment of the invention. As illustrated in FIG. 1, the image processing system includes a reading device 40, an image forming device 50, and a verifying device 60.

The reading device 40 is a device including an image sensor 70. The reading device 40 reads the outward appearance of an individual object with the image sensor 70, and acquires randomness feature information that represents the randomness of the outward appearance of the individual object. In the first exemplary embodiment, a paper fingerprint is read as the randomness of the outward appearance of an individual object. A paper fingerprint refers to microscopic patterns that exist on the surface of a paper medium 80. The term “microscopic” refers to a state in which phenomena are so minute as not to be identifiable by human senses. Unlike, for example, general indications such as letters and graphical figures drawn on the surface of the paper medium 80, microscopic patterns are fine patterns that are basically imperceptible to the naked eye. Some kinds of individual objects intrinsically have microscopic patterns formed naturally on their surface. For example, the paper medium 80 used in the first exemplary embodiment is created by entanglement of fine fibers made from wood pulp as their raw material. The random entanglement of these natural fibers creates a paper fingerprint as microscopic patterns. While the first exemplary embodiment is directed to a case in which the paper medium 80 is used as an individual object and a paper fingerprint is read as patterns appearing on the surface of the paper medium 80, this is not intended to be restrictive. For example, a plastic substrate or the like may be used. The reading device 40 acquires paper fingerprint feature information from the paper fingerprint that has been read, and converts the paper fingerprint feature information into a machine readable coded information such as a bar code, a two-dimensional code, or a QR Code®.

The image forming device 50 is, for example, a multi-function machine having functions such as a copy function, a printer function, an image scanner function, and a facsimile function. In the first exemplary embodiment, the image forming device 50 attaches and prints a coded image 82 onto the paper medium 80 as coded information. The image forming device 50 may attach the coded image 82 simultaneously with printing of an image onto the paper medium 80.

The verifying device 60 is a device including the image sensor 70. For the paper medium 80 immediately after having the coded image 82 printed thereon by the image forming device 50, the verifying device 60 verifies whether paper fingerprint feature information obtained by reading the coded image 82 printed by the image forming device 50 with the image sensor 70 matches paper fingerprint feature information obtained at a predetermined position. The verifying device 60 may be the same device as the reading device 40. Alternatively, the reading device 40 may operate as the verifying device 60.

In the first exemplary embodiment, when creating a certificate that is not allowed to be duplicated such as an ID card or a passport, paper fingerprint feature information of an original is registered to the original as authentication information used for authenticating whether or not the certificate in question is an original. Specifically, paper fingerprint feature information at a predetermined position in an original is acquired, and coded information obtained by converting the acquired paper fingerprint feature information into a code is registered to the original. Then, when authenticating whether or not an object being authenticated (hereinafter, referred to as “authentication object”) is an original, paper fingerprint feature information corresponding to the coded information registered to the authentication object, and paper fingerprint feature information at a predetermined position in the authentication object are compared against each other to verify whether the authentication object is an original. Then, in a case in which a match occurs between the paper fingerprint feature information corresponding to the coded information, and the paper fingerprint feature information obtained at the predetermined position in the authentication object, the authentication object is determined to be an original.

In this regard, cases may arise in which, when registering coded information of paper fingerprint feature information obtained at a predetermined position in an original to the original as authentication information, a failure occurs in the registration. Specifically, such cases include when the reading position for the paper fingerprint is displaced, or when coded information is no successfully registered to a medium due to double-feed in the image forming device. The first exemplary embodiment allows such a code information registration error to be discovered at the time of registration of the coded information.

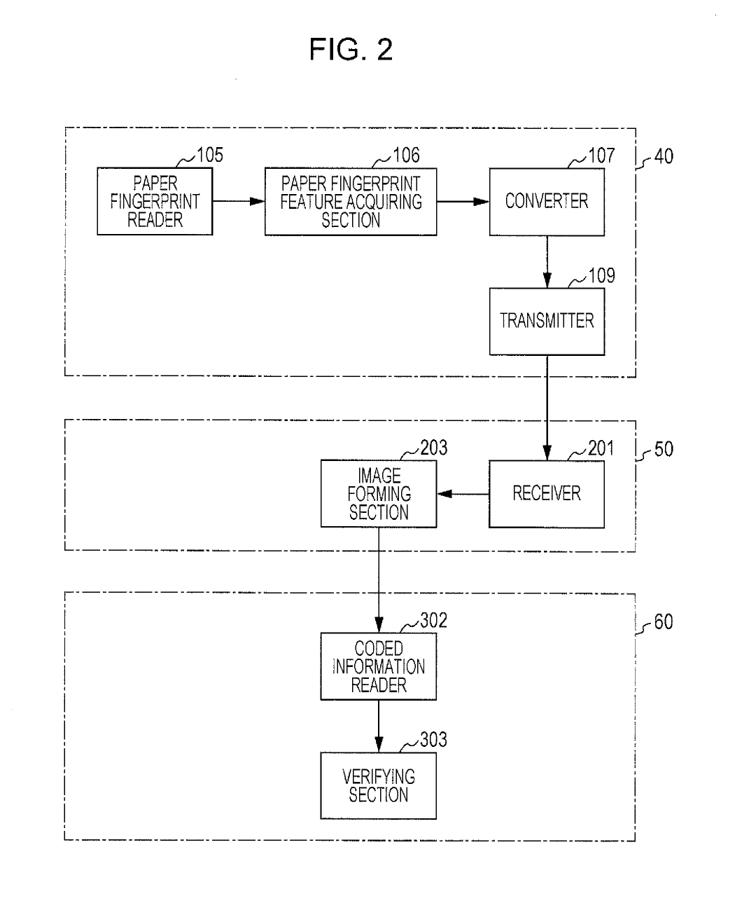

FIG. 2 is a block diagram illustrating an example of functions respectively executed by the reading device 40, the image forming device 50, and the verifying device 60 according to the first exemplary embodiment. As illustrated in FIG. 2, the reading device 40 includes a paper fingerprint reader 105, a paper fingerprint feature information acquiring section 106, a converter 107, and a transmitter 109. In the reading device 40 according to the first exemplary embodiment, functions other than the functions illustrated in FIG. 2 may be realized. These functions are realized by execution of a program stored in a memory by a controller. For example, this program is supplied to the reading device 40 via a computer readable information storing medium such as an optical disc, a magnetic disk, a magneto-optical disk, or a flash memory, or via a communication section such as the Internet.

The image forming device 50 includes a receiver 201, and an image forming section 203. In the image forming device 50 according to the first exemplary embodiment, functions other than the functions illustrated in FIG. 2 may be realized. These functions are realized by execution of a program stored in a memory by a controller. For example, this program is supplied to the image forming device 50 via a computer readable information storing medium such as an optical disc, a magnetic disk, a magneto-optical disk, or a flash memory, or via a communication section such as the Internet.

The verifying device 60 includes a coded information reader 302, and a verifying section 303. In the verifying device 60 according to the first exemplary embodiment, functions other than the functions illustrated in FIG. 2 may be realized. These functions are realized by execution of a program stored in a memory by a controller. For example, this program is supplied to the verifying device 60 via a computer readable information storing medium such as an optical disc, a magnetic disk, a magneto-optical disk, or a flash memory, or via a communication section such as the Internet.

The paper fingerprint reader 105 of the reading device 40 scans the surface of the paper medium 80 that is an original (hereinafter, referred to as original) with the image sensor to thereby read a paper fingerprint image of the entirety or a part of the original. Specifically, the paper fingerprint reader 105 reads patterns appearing on the surface of an original, for example, the patterns of fibers forming the original. Alternatively, the paper fingerprint reader 105 may be configured to read patterns formed by minute cracks in the surface of an original, fine particles of a material, or the like.

The paper fingerprint feature information acquiring section 106 of the reading device 40 acquires paper fingerprint feature information from at least one predetermined sampling region in the paper fingerprint image read by the paper fingerprint reader 105. The sampling region may be either the entirety of the original, or at least one partial region on the original. Further, together with the paper fingerprint feature information, the paper fingerprint feature information acquiring section 106 acquires positional information of the sampling region. Specifically, multiple regions are set within an image, and the paper fingerprint feature information acquiring section 106 acquires paper fingerprint feature information of the multiple regions. Each of the regions corresponds to, for example, the smallest region necessary for acquiring paper fingerprint feature information. Positional information on paper fingerprint feature information corresponds to positional information regarding the multiple regions. Positional information is expressed in x- and y-coordinates in a case where a given point on the original (for example, an edge of the original) is taken as the origin, with the horizontal direction and vertical direction of the original as an x-axis and a y-axis, respectively. In a case where an original is not a rectangle, positional information may be expressed as vectors or the like from the origin.

The converter 107 of the reading device 40 converts the paper fingerprint feature information acquired by the paper fingerprint feature information acquiring section 106 into machine readable coded information. Specifically, the converter 107 applies discrete cosine transform or the like to the paper fingerprint feature information to compress the paper fingerprint feature information, and on the basis of the compressed data, the converter 107 generates bitmap data to be printed onto the original as coded information in a format that is automatically machine readable. Data compression may not necessarily be performed. Instead, coding may be performed without performing compression. Alternatively, compression/coding may be performed after attaching positional information indicative of the position of a sampling region to the acquired paper fingerprint feature information. In a case where a sampling region is to be selected from multiple candidate regions, identification information (candidate region ID) such as a number for identifying each individual candidate region may be defined in advance, and this candidate region ID may be used as positional information of a sampling region. In a case where it is necessary to distinguish multiple originals from one another, identification information for identifying each original (such as the very image displayed in the original, or feature information extracted from the image) may be separately printed onto the original. Data encryption may be also performed.

The transmitter 109 of the reading device 40 transmits the coded information converted by the converter 107 to the image forming device 50.

The receiver 201 of the image forming device 50 receives the coded information transmitted by the transmitter 109 of the reading device 40, and outputs the received coded information to the image forming section 203.

The image forming section 203 of the image forming device 50 prints the coded information acquired from the reading device 40 onto the corresponding original. A coded information printing region on which to print coded information is set in at least one region where the texture of paper is exposed and on which no printing or writing is performed. For example, a candidate region that may be set as a coded information printing region is set in advance in at least one predetermined location across the entire original, and at least one such candidate region is selected as a coded information printing region. Alternatively, the image forming section 203 may set a coded information printing region on the basis of the positional information of a sampling region acquired by the paper fingerprint feature information acquiring section 106.

The image forming section 203 of the image forming device 50 may print, together with the coded information acquired from the reading device 40, information related to this coded information (for example, an ID number, a face photograph, and a name) onto the corresponding original.

The coded information reader 302 of the verifying device 60 reads the coded information printed on the original with the image sensor, thereby acquiring paper fingerprint feature information corresponding to the coded information.

The verifying section 303 of the verifying device 60 searches for a portion that matches the paper fingerprint feature information acquired by the coded information reader 302, on the original. The verifying section 303 determines a verification region, which is a region to be searched for a portion that matches the paper fingerprint feature information acquired from the coded information, on the basis of the positional information of a sampling region acquired by the paper fingerprint feature information acquiring section 106 of the reading device 40. At this time, if the verification region is set to the same size as the sampling region, even a slight displacement of the read position may make it difficult to perform verification. Accordingly, the verification region is set larger than the sampling region so that the sampling region may be included in the verification region even if the position of the original is displaced, and a portion that matches the paper fingerprint feature information corresponding to the coded information is searched for within the image of a paper fingerprint in the verification region. For example, if, within the image of the verification region, there is a portion where the value of correlation of the pixel value of a paper fingerprint image corresponding to the coded information is higher than or equal to a predetermined threshold, the verifying section 303 determines that there is a match with the paper fingerprint image corresponding to the coded information.

Registration of authentication information (coded information obtained by coding paper fingerprint feature information) to the original is completed when the verifying section 303 determines that there is a match. Registration of authentication information to the original fails when the verifying section 303 determines that there is no match. The verifying device 60 may output an error signal in the form of a warning display or warning sound when it is determined as a result of verification by the verifying section 303 that there is no match.

The verifying device 60 may have multiple output portions that output an original that has undergone verification by the verifying section 303. The verifying device 60 outputs the original to different output portions depending on whether or not it is determined that there is a match as a result of verification by the verifying section 303. Consequently, it is possible to distinguish an original for which registration of authentication information has failed from other originals. The verifying device 60 may also suspend the operation of some or all of the reading device 40, the image forming device 50, and the verifying device 60 in a case where it is determined as a result of verification by the verifying section 303 that there is no match.

### Second Exemplary Embodiment

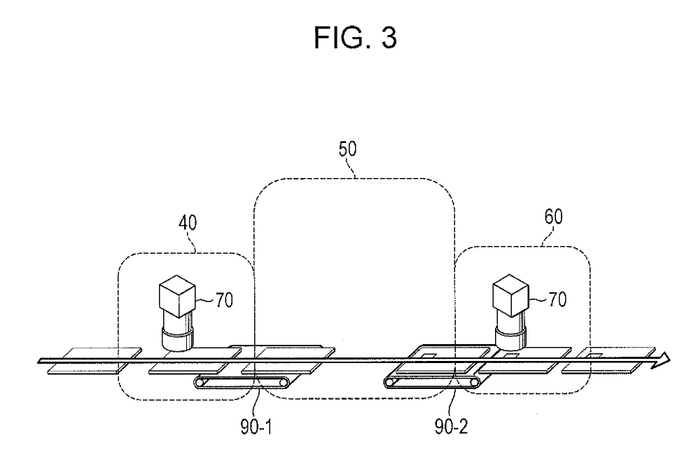

In a second exemplary embodiment, an image processing system includes transport mechanisms 90-1 and 90-2 (see FIG. 3) that transport a paper medium between the reading device 40, the image forming device 50, and the verifying device 60 according to the first exemplary embodiment. The transport mechanisms 90-1 and 90-2 are each configured by a roller, a belt, or the like, and cause a paper medium such as cut paper or rolled paper to move. FIG. 3 illustrates an example of the configuration of an image processing system according to the second exemplary embodiment. An original from which paper fingerprint feature information has been acquired by the reading device 40 and which has been sent out from the reading device 40 is passed to the image forming device 50 by the transport mechanism 90-1. Then, when the original is sent out from the image forming device 50 after having coded information or the like printed thereon, the original is passed to the verifying device 60 by the transport mechanism 90-2.

### Third Exemplary Embodiment

In a third exemplary embodiment, an image processing system includes a comparison device 100. The comparison device 100 makes a true/false determination as to whether a document on which coded information is printed (hereinafter, referred to as comparison object) is an original.

The comparison device 100 is a device including the image sensor 70. The comparison device 100 acquires paper fingerprint feature information by reading coded information, which is printed on a comparison object, with the image sensor 70, and searches for a portion that matches the paper fingerprint feature information that has been read, on the comparison object. Specifically, the comparison device 100 acquires positional information of a sampling region included in the coded information, and on the basis of the positional information of a sampling region, the comparison device 100 determines a comparison region, which is a region to be searched for a portion that matches the paper fingerprint feature information acquired from the coded information. At this time, if the comparison region is set to the same size as the sampling region, even a slight displacement of the read position may make it difficult to perform comparison. Accordingly, the comparison region is set larger than the sampling region so that the sampling region may be included in the comparison region even if the position of the comparison object is displaced, and a portion that matches paper fingerprint feature information corresponding to the coded information is searched for within the image of a paper fingerprint in the comparison region. For example, if, within the image of the comparison region, there is a portion where the value of correlation of the pixel value of a paper fingerprint image corresponding to the coded information is higher than or equal to a predetermined threshold, the comparison device 100 determines that there is a match with the paper fingerprint feature information corresponding to the coded information. The comparison device 100 may be the same device as the verifying device 60 or the reading device 40. Alternatively, the reading device 40 or the verifying device 60 may operate as the comparison device 100.

In a case where the comparison device 100 determines that there is a match, the comparison object is authenticated as an original, and in a case where the comparison device 100 determines that there is no match, authentication fails. The comparison device 100 may output an error signal in a case where authentication fails. For example, in authentication of entry/exit using an ID card, an entrance or exit gate may not be opened in a case where authentication fails.

Exemplary embodiments of the invention are not limited to the above-mentioned exemplary embodiments.

For example, in the above embodiments, coded information of a paper fingerprint image acquired from an original is printed onto the original. However, alternatively, a paper fingerprint image acquired from an original, paper fingerprint feature information acquired from the paper fingerprint image, and coded image data generated on the basis of coded information may be stored on a server or the like in association with one another. In this case, the verifying device 60 or the comparison device 100 acquires paper fingerprint feature information from the server, and searches for a portion on the original which matches the acquired paper fingerprint feature information.

The reading device 40 may determine whether or not a paper fingerprint image read by the paper fingerprint feature acquiring section 106 satisfies a predetermined criterion. Examples of this criterion include the density distribution of the image of a sampling region, and a print pattern in a sampling region. Then, in a case where the reading device 40 determines that the criterion is not satisfied, an error signal is outputted and the operation of the reading device 40 is suspended.

The reading device 40 may read the size of a paper medium, and determine whether or not the read size is a predetermined size. Then, in a case where the reading device 40 determines that the read size is not a predetermined readable size, an error signal is outputted and the operation of the reading device 40 is suspended.

The foregoing description is directed to the case where the information processing system includes the paper fingerprint feature information acquiring section 106 and the converter 107. However, this is not intended to be restrictive. Alternatively, paper fingerprint feature information acquired by the paper fingerprint feature information acquiring section 106 of the reading device 40 may be transmitted to the image forming device 50, and the image forming device 50 may convert the received paper fingerprint feature information into coded information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing system comprising:
a randomness feature information acquiring section that acquires randomness feature information from an individual object having randomness unique to an outward appearance of the individual object, the randomness feature information representing a feature of the outward appearance;
a coded information attaching section that attaches coded information of the acquired randomness feature information to the individual object corresponding to the coded information; and
a verifying section that verifies whether the randomness feature information corresponding to the coded information of the individual object attached with the coded information is the randomness feature information acquired from the individual object attached with the coded information.

2. The image processing system according to claim 1, wherein the coded information includes positional information, the positional information indicating a position in the individual object at which the randomness feature information is acquired.

3. The image processing system according to claim 2, wherein the coded information attaching section attaches the coded information of the randomness feature information to a position based on the positional information.

4. The image processing system according to claim 2, wherein the verifying section verifies whether the randomness feature information corresponding to the coded information of the individual object attached with the coded information is the randomness feature information acquired from a position based on the positional information in the individual object attached with the coded information.

5. An image processing system comprising:
a reading device;
an image forming device; and
a verifying device,
wherein the reading device includes a randomness feature information acquiring section, the randomness feature information acquiring section acquiring randomness feature information from an individual object having randomness unique to an outward appearance of the individual object, the randomness feature information representing a feature of the outward appearance,
wherein the image forming device includes a coded information attaching section, the coded information attaching section attaching coded information of the acquired randomness feature information to the individual object corresponding to the coded information, and
wherein the verifying device includes a verifying section, the verifying section verifying whether the randomness feature information corresponding to the coded information of the individual object attached with the coded information is the randomness feature information acquired from the individual object attached with the coded information.

6. The image processing system according to claim 5, further comprising a transport section that transports the individual object between the reading device, the image forming device, and the verifying device.

7. The image processing system according to claim 1, further comprising:
a plurality of output portions that output the individual object that has been verified by the verifying section,
wherein the individual object is outputted to a different one of the output portions depending on a result of verification by the verifying section.

8. The image processing system according to claim 1, wherein:
the randomness feature information acquiring section acquires paper fingerprint feature information, the paper fingerprint feature information being generated on a basis of an image of patterns on a paper medium; and
the coded information attaching section prints a coded image generated from the paper fingerprint feature information onto the paper medium.

9. A non-transitory computer readable medium storing a program causing a computer to execute a process, the process comprising:
acquiring randomness feature information from an individual object having randomness unique to an outward appearance of the individual object, the randomness feature information representing a feature of the outward appearance;
attaching coded information of the acquired randomness feature information to the individual object corresponding to the coded information; and
verifying whether the randomness feature information corresponding to the coded information of the individual object attached with the coded information is the randomness feature information acquired from the individual object attached with the coded information.

10. An image processing method comprising:
acquiring randomness feature information from an individual object having randomness unique to an outward appearance of the individual object, the randomness feature information representing a feature of the outward appearance;
attaching coded information of the acquired randomness feature information to the individual object corresponding to the coded information; and
verifying whether the randomness feature information corresponding to the coded information of the individual object attached with the coded information is the randomness feature information acquired from the individual object attached with the coded information.
